(19) United States
(12) Patent Application Publication
(10) Pub. No.: US 2008/0311392 A1
(43) Pub. Date: Dec. 18, 2008

(54) Thermal barrier

(75) Inventor: David V. Tsu, Auburn Hills, MI (US)

Correspondence Address: Kevin L. Bray;Ming Scientific, LLC, 2142 Pontiac Road #104, Auburn Hills, MI, 48326, US

(73) Assignee: Ming Scientific, LLC

(21) Appl. No.: 12/157,531

(22) Filed: Jun. 11, 2008

Related U.S. Application Data
(60) Provisional application No. 60/934,286, filed on Jun. 12, 2007.

(51) Int. Cl. B32B 3/00

(52) U.S. Cl. 428/336; 428/221; 428/689

(57) ABSTRACT

A composite thermal barrier material. The material includes a support layer coated on one or both sides with an infrared active material to improve thermal retention characteristics. The support layer is typically a flexible organic or polymer material. The infrared active material increases reflectance of thermal infrared radiation and reduces the flow of heat from the interior side of the barrier to the external surroundings. The infrared active material operates through vibrational absorption in the infrared and/or free carrier absorption. Representative infrared active materials include oxides, transparent conductors, and nanoscale metals.

### RELATED APPLICATION INFORMATION

This application claims priority from U.S. Provisional Patent Application Ser. No. 60/934,286, entitled “Method to enhance thermal infrared reflection and reduce infrared emission, from synthetic organic materials and fibers, and from natural organic fibers, using infrared active coatings” and filed on Jun. 12, 2007, the disclosure of which is incorporated by reference in its entirety herein.

### FIELD OF INVENTION

This invention relates to a thermal barrier for inhibiting heat losses from interior spaces. More particularly, this invention relates to a composite material that enables management of infrared radiation in the thermal spectral range. Most particularly, this invention relates to a lightweight plastic or organic material having a coating designed to enhance infrared reflectance and/or to lower infrared emissivity.

### BACKGROUND OF THE INVENTION

Thermal energy management is concerned with the general problem of retaining or confining heat within specified boundaries and inhibiting heat losses through the boundaries. The agricultural greenhouse is a classic example of a thermal energy management system. In a greenhouse, the objective is to localize heat in an interior region defined by the greenhouse boundaries and to create an interior that is warmer than the exterior region surrounding the boundaries. The greenhouse boundary is comprised of a thermal barrier material that (1) efficiently transmits solar radiation from the exterior to the interior and (2) efficiently prevents transmission of infrared thermal energy from the interior back to the exterior. Objects (such as crops) within the interior of the greenhouse are heated to favorable growing conditions through absorption of the solar energy incident to the greenhouse. As the interior objects heat and their temperature increases, they emit an increasing amount of infrared thermal radiation. If the emitted radiation were allowed to escape to the exterior, the interior objects would cool and equilibrate with the temperature of the exterior. By inhibiting the escape of infrared thermal energy, the boundaries of a greenhouse confine the energy to the interior and insure that objects within the interior remain warm. In the case of crops, confinement of thermal energy within a greenhouse provides an economic benefit by extending the growing season.

Glass plate has traditionally been the thermal barrier material of choice for constructing the boundaries of a greenhouse. Glass is an effective thermal barrier material because of its fairly high reflectance of thermal infrared (IR) radiation that is emitted from the warm garden contained within. Visible light (VIS) and near infrared (NIR) solar energy transmits through the glass, which is then absorbed by the crops or other interior objects, thereby heating them. This thermal energy then radiates back out to space as blackbody radiation in the “thermal” IR band. Due to a very strong coupling between this IR energy and the Si—O vibrations within glass however, the glass surface acts as a radiant barrier to the transmission of IR energy to the exterior of the greenhouse. This IR energy is therefore trapped by the glass and returned (i.e., reflected) back to the interior where it can be re-absorbed to maintain an interior temperature that is higher than the ambient background temperature outside the greenhouse. This reflection occurs even if the glass and ambient temperatures are equally cold.

Despite the beneficial thermal barrier characteristics of glass, use of glass as a greenhouse boundary suffers from several drawbacks. First, the intrinsic cost of glass is high (>$6.50/ft²). Second, glass is a brittle material and must be sufficiently thick to prevent inadvertent fractures. As a result, glass barriers are heavy and inconvenient to move or reconfigure. Third, glass must be tempered for improved safety and this results in further increases in its cost. These drawbacks tend to limit the practical application of glass-based greenhouses to compact, garden-sized structures.

Plastics and other organic materials have been viewed as an attractive alternative to glass as a thermal barrier material because they are inexpensive, light weight, flexible and durable materials. A number of manufacturers offer plastic greenhouses that utilize Plexiglas, Mylar, polycarbonate, polyethylene, polypropylene or other organic barrier material. Plastics, however, are less than optimal thermal barriers because their reflectivity of thermal IR radiation is very poor. Instead of efficiently reflecting thermal radiation emanating from the interior back to the interior, common plastics tend either to transmit infrared radiation from the interior to the exterior surroundings or to absorb incident infrared energy and dissipate it internally within the plastic material. With transmission, the plastic is basically transparent to the IR energy and this energy radiates directly into space, never to be returned. If absorbed, the IR energy could in principle re-radiate back into the interior. The problem, however, is that the plastic will be at the cooler ambient (exterior) temperature, thus any re-radiation back into the garden will be significantly reduced. Radiation to the exterior, plus thermal conduction and convection exacerbate thermal losses from or through a plastic boundary to the exterior.

Some manufacturers attempt to compensate for the poor radiant barrier performance of plastic by offering multi-walled plastic greenhouse boundaries to increase the R-value of plastics (where R-value is the resistance to the flow of thermal energy). In one example, a greenhouse boundary that includes with three to five polycarbonate (PC) panels and two to four intervening air spaces is used to achieve a higher R-value and improved thermal infrared insulative performance. The drawback to multi-walled plastic barriers is a marked reduction in the transmission of incident solar energy. For example, one PC panel has a visible light transmission (λ=550 nm) of about 0.90, while combinations of three and five panels have transmissions of only 0.72 and 0.58, respectively. This means that the primary solar energy source has been reduced by these amounts.

A need therefore exists for a thermal barrier material for greenhouse and heat retention applications that is flexible and light weight with high transmission of visible (or shorter wavelength) radiation (as with plastics) and with low transmission and high reflection of infrared (or longer wavelength) radiation (as with glass).

### SUMMARY OF THE INVENTION

This invention provides a thermal barrier material that permits high retention of thermal infrared radiation. The material combines glass-like solar transmissivity and thermal insulative properties with the light weight and flexibility of a plastic.

In one embodiment, the thermal barrier material is a composite material that includes a layer of plastic or organic material and a layer of an infrared active material. The plastic or organic material may be a carbon-based polymer or a silicon-based polymer. Representative plastics and organic materials include natural fibers and materials as well as synthesized materials such as polyethylene, polypropylene, polycarbonate, polyethyleneterephthalate, nylon, polyester, block copolymers, polymer blends, fabrics, polysiloxane, and polysilicone. The layer of infrared active material may be a transparent dielectric that may or may not be an electrically conductive material. Representative infrared active materials include metal oxides, silicon dioxide, germanium dioxide, metal nitrides, silicon nitride, and oxides or nitrides that contain microscale or nanoscale metal regions.

The plastic or organic layer of the instant composite thermal barrier material is thin and provides a flexible substrate for the deposition of the infrared active material. The infrared active material serves as a coating of the plastic or organic layer that imparts high insulative performance in the thermal infrared energy range. In one embodiment, the infrared active material includes bonds or molecular fragments that exhibit strong absorption or reflection in the infrared frequency range. In these materials, the vibrational frequency of one or more bonds or molecular fragments coincides with the frequency of thermal infrared radiation emitted by objects confined within the thermal barrier material. Bonds of oxygen or nitrogen with a metal or silicon, for example, exhibit high infrared coupling (or absorption) of thermal radiation. In a further embodiment, multiple (layered or heterogeneously mixed) infrared active materials are combined to provide broader overlap of vibrational frequencies with the spectrum of thermal infrared radiation.

In another embodiment, the infrared active material includes a transparent matrix that supports microscale or nanoscale metal particles. In this embodiment, the metal particles include a high free electron concentration and exhibit strong free carrier absorption in the thermal infrared radiation. By controlling the thickness, spatial distribution and size of the metal particles and the nature of its clustering properties, strong thermal infrared insulative properties can be achieved while retaining the good solar or visible transmissivity required for greenhouse barrier applications.

### BRIEF DESCRIPTION OF THE DRAWINGS

FIG. 1 illustrates the infrared reflection spectrum of several organic materials.

FIG. 2 compares the absorption spectrum of SiO₂ and the absorption spectrum of PET (Mylar) in the infrared spectral range.

FIG. 3 shows comparisons of the reflectivity of fused silica glass (FSG) and PET in the infrared with the room temperature blackbody radiation spectrum.

FIG. 4 schematically depicts selected composite thermal barrier materials in accordance with the instant invention.

FIG. 5 shows a comparison of the reflectance spectra of PET, fused silica glass, and a composite material that includes a layer of SiO₂ on PET.

FIG. 6 shows the calculated thermal efficiency in the thermal infrared spectral range for fused silica glass and several polymer materials.

FIG. 7 shows the calculated thermal efficiency in the thermal infrared spectral range of SiO₂-coated PET as a function of the thickness of the SiO₂ coating.

FIG. 8 shows the reflectance spectrum, transmission spectrum, reflection efficiency and transmission efficiency of an Al film as a function of free carrier concentration.

FIG. 9 illustrates an embodiment in which an infrared active material is applied to the outer surface of a textile.

FIG. 10 illustrates an embodiment in which an infrared active material is applied to the individual fibers or threads used to make textiles.

### DETAILED DESCRIPTION OF THE ILLUSTRATED EMBODIMENTS

Although this invention will be described in terms of certain preferred embodiments, other embodiments that are apparent to those of ordinary skill in the art, including embodiments that do not provide all of the benefits and features set forth herein, are also within the scope of this invention. Accordingly, the scope of the invention is defined only by reference to the appended claims.

This invention provides superior thermal barrier materials for use in greenhouses and other applications where it is desirable to localize heat or to prevent the transfer of heat in a particular direction or through a particular boundary. An important aspect of the instant barrier material is its ability to confine or retain thermal infrared radiation within specified boundaries. The instant barrier material provides high thermal infrared reflectivity and/or low thermal infrared emissivity. Although good thermal energy retention characteristics are known in glass, they have heretofore not been achieved in a light weight, flexible material due to molecular considerations that we now describe.

Electromagnetic radiation is emitted from objects according to their temperature. The spectral range of the thermal radiation is governed by the blackbody radiation law. As the temperature of an object increases, the spectral range of radiation frequencies broadens and the peak radiation frequency shifts to shorter wavelength. At room temperature, blackbody thermal radiation peaks in the infrared at a wavelength of about 10 μm (1000 cm⁻¹) and has a spectral range that extends from about 5 μm to beyond 30 μm. In order for a barrier material to be effective in the thermal infrared spectral range, it must efficiently reflect or otherwise confine wavelengths in the 10 μm spectral range. In order to function as an effective thermal barrier, a material must have infrared spectral properties that sufficiently overlap the thermal radiative spectrum emitted by objects confined by the barrier.

A significant problem in the art of thermal barrier materials is that materials having infrared spectral properties that overlap well with and strongly couple to IR thermal blackbody radiation emitted at or near room temperature tend to be brittle, heavy or expensive, while materials that are flexible and inexpensive tend to have poor spectral overlap with and only weakly couple with the thermal infrared radiation emitted by objects near room temperature. The most cost-effective flexible materials are plastics or other organic materials. These materials primarily contain carbon, nitrogen, oxygen, and hydrogen and have infrared spectral properties that are largely defined by bonds between these elements. The frequency of infrared reflection or absorption of a material is controlled by the strength of bonds between atoms and the mass of the atoms, while the intensity of infrared reflection or absorption controlled by bond polarity (dipole strength). In terms of atomic mass, stretching vibrations of carbon-carbon, carbon-nitrogen, and carbon-oxygen bonds occur in the vicinity of 10 μm. These vibrations, however, are accompanied by weak dipoles and, consequently, poor coupling to infrared radiation. As a result, the oscillator strengths (intensity) of the most prevalent vibrations in plastics or other organic materials are weak and these materials tend to have poor thermal insulative characteristics as a result.

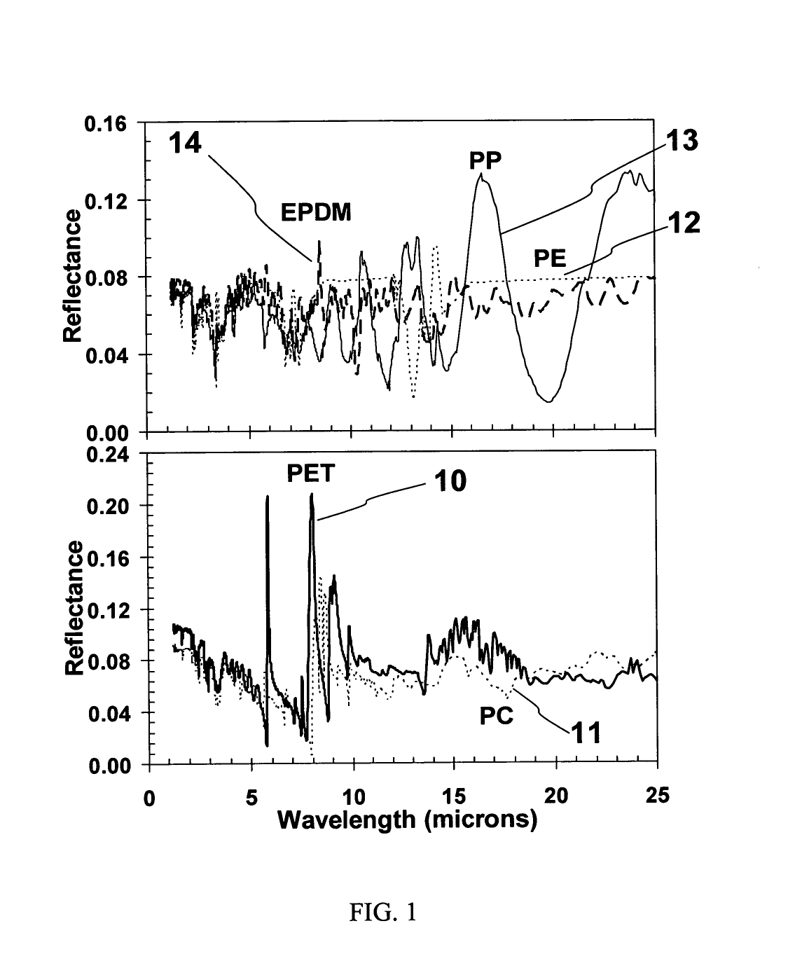

As an illustrative example, FIG. 1 shows the reflectance spectrum in the infrared for several organic polymers. The reflectance spectrum shows the fraction of incident infrared radiation reflected by each polymer as a function of the wavelength of radiation. Reflectance spectra are shown for Mylar (polyethylene terephthalate (PET), Trace 10), polycarbonate (PC, Trace 11), polyethylene (PE, Trace 12), polypropylene (PP, Trace 13), and ethylenepropylenediene terpolymer (EPDM, Trace 14). Although all of the polymers exhibit reflectivity in the vicinity of 10 μm, the reflectivity bands are weak (low reflective intensity) and narrow. At the 10 μm peak of the room temperature thermal emission spectrum, for example, the polymers all exhibit a reflectivity of only about 8%. Narrow reflection bands indicate that the polymers exhibit infrared activity only over narrow wavelength ranges in the thermal infrared spectral range. The polymers are inactive with respect to a substantial portion of the blackbody thermal spectrum.

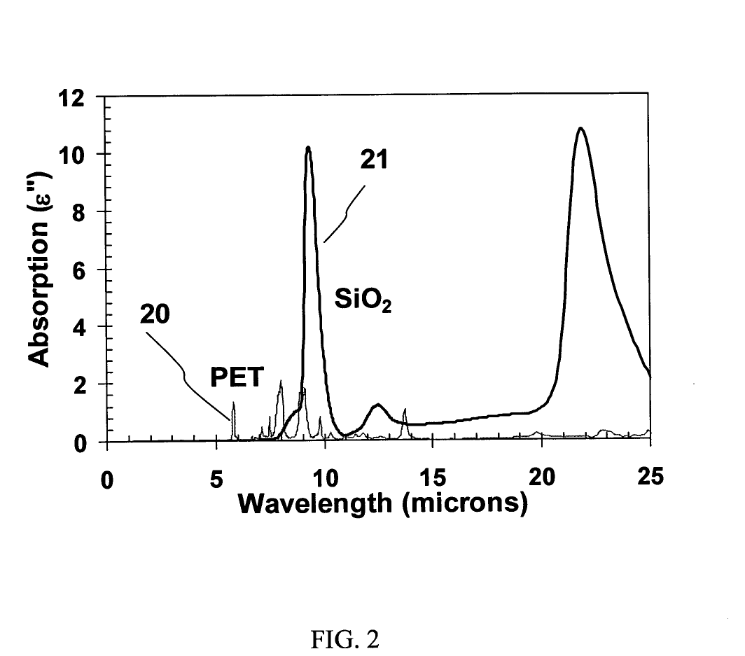

FIG. 2 shows a comparison of the infrared absorption spectra of PET, one of the better polymers, and SiO₂, the primary constituent of conventional glass. The infrared absorption of a material correlates with its infrared reflectivity through the Kramers-Kronig relation. The infrared absorption bands of SiO₂ are much more intense and much broader than those of PET. The superior infrared spectral properties of SiO₂ are responsible for its good thermal insulative properties and are a consequence of the strong ability of silicon-oxygen bonds to couple to an incident infrared electromagnetic field. The strong absorption feature of SiO₂ that peaks at 9.3 μm is due to the silicon-oxygen stretching vibration. This vibrational mode shows strong infrared absorption because of the high polarity of the Si—O bond, which results in a strong electric dipole that enables coupling to infrared radiation. (Bond polarity is a consequence of the difference in electronegativity of the constituent atoms. The electronegativities of oxygen, silicon, and carbon, for example, are 3.44, 1.90 and 2.55, respectively. The electronegativity difference for a Si—O bond (1.54) is much greater than the electronegativity difference of a C—C bond (O) or a C—O bond (0.89).) The 9.3 μm peak wavelength correlates well with the 10 μm peak of room temperature thermal infrared emission and its strong intensity corresponds to an infrared reflectivity of over 70%. The high reflectivity and broad wavelength range of the Si—O stretching frequency is the primary attribute of SiO₂ that imparts its superior thermal insulative properties. The spectral absorption bands of SiO₂ at 12.3 μm and 22 μm are due to bending and rocking modes, respectively, of O—Si—O units and related groups and contribute secondarily to the thermal insulative properties of SiO₂ at temperatures near room temperature. Similar thermal insulative benefits are expected from Si—N stretching, and bending vibrational modes.

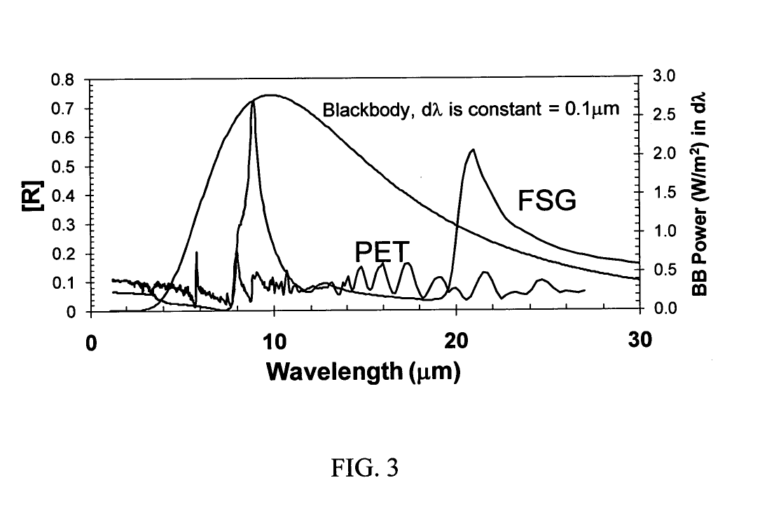

FIG. 3 shows a comparison of the reflectivity of a common SiO₂-based glass (fused silica glass (FSG)) and the reflectivity of PET in the infrared with the room temperature blackbody radiation spectrum. The reflectivity of FSG and PET are quantified by the left side ordinate ([R]) and are shown as a function of wavelength. The thermal blackbody emission is quantified by the right side ordinate (BB Power) and is also shown as a function of wavelength. FIG. 3 shows the greater than 70% peak reflectivity of the 9.3 μm band of FSG and illustrates the much greater spectral overlap of FSG relative to PET with the thermal blackbody spectrum.

In this invention, a thermal barrier material is provided that combines high infrared reflectivity with flexibility and low cost. The instant material is a composite material that utilizes a polymer or organic material as a base material to achieve flexibility and strength and an infrared active coating to enhance thermal insulative performance. The instant inventor has recognized that the superior insulative properties of SiO₂ may be achieved in thin layers of SiO₂. Glass panes used for greenhouse applications are made thick to provide mechanical stability and minimize the risk of fracture. The infrared spectral properties of SiO₂, however, are controlled by the surface region. Because of the strong infrared absorption of SiO₂, the penetration depth of infrared light into glass is small. As a result, only a thin region (˜2 μm) near the surface of glass interacts with incident infrared emission and is responsible for the infrared spectral properties of glass. The remaining thickness of the glass is unnecessary from the perspective of thermal insulative characteristics and merely provides mechanical support.

Accordingly, a thin layer of SiO₂ (or similarly effective infrared absorbing or reflecting material) is expected to function effectively as a thermal radiative barrier material. Because of poor mechanical stability, however, a thin layer of SiO₂ cannot be used in isolation. Thin layers of polymers and other organic materials, however, are mechanically stable and can serve as a substrate to support a thin layer of SiO₂ or other infrared active material.

One embodiment of the instant invention provides a composite thermal barrier material that includes a support layer comprised of a polymer or other organic material and an infrared active layer comprised of a material that has high infrared absorption, high infrared reflectivity and/or low infrared emissivity. The support layer may also be referred to herein as a base layer.

The support layer is generally a carbon-based material that is made as thin as possible to insure flexibility while maintaining adequate mechanical support. Since the support layer contributes only weakly to the infrared thermal insulative properties of the barrier material and may detract from the transmission of shorter wavelength visible light (such as the visible part of the solar spectrum), it is desirable for the support layer to be as thin as possible consistent with the goal of obtaining a flexible and durable barrier material. Representative support layers include polyethylene, polypropylene, polycarbonate, polyethyleneterephthalate, ethylenepropylenediene terpolymer, and polyurethane. Support layers within the scope of the instant invention include cloth, fabrics, clothing, and wallpaper.

The infrared active layer is a material that shows strong coupling to infrared radiation. In one embodiment, the infrared active material couples to incident infrared radiation through vibrational absorption. Such materials may be referred to herein as “vibrational infrared active materials”. Representative infrared active materials having good vibrational spectral overlap with thermal blackbody emission in the infrared include materials having Si—O, Si—N, Al—O, Al—N, Zn—O, Zn—S, or Zn—Se bonds. More generally, materials having bonds between a metal and either a column V (e.g. N, P, As) or column VI (e.g. O, S, Se, Te) element may serve as infrared active materials within the scope of the instant invention. The metal element may be a transition metal or post-transition metal element. Examples include SiO₂, TiO₂, SiNₓ, TiN, AlN, ZnS, ZnO, ZnSe, SiC, GeO₂, KBr, MO (where M is a divalent metal), and M₂O₃ (where M is a trivalent metal).

The thickness of the vibrational infrared active material is intended to exceed the thickness of such materials used for anti-reflection applications in the visible. SiO₂ and related materials have been used as coatings on plastics to achieve an anti-reflection capability. In particular, lenses are frequently coated with SiO₂ or similar material to reduce reflection of light incident to the surface of the lens. Because the refractive index of plastic is much higher than that of air, significant reflection of incident visible light occurs at the air-plastic interface. The refractive index of SiO₂ is intermediate between the refractive indices of air and plastic and provides an anti-reflective capability when used as a lens coating. In order to provide anti-reflective functionality, however, the thickness of the SiO₂ layer must be sufficiently thin to permit destructive interference of reflected visible light. As the thickness of the SiO₂ layer increases and approaches the incoherent limit (which occurs at thicknesses of a few hundred nanometers), destructive interference does not occur and the anti-reflective characteristics are lost. The prior art thus teaches away from utilizing thick SiO₂ coatings so that anti-reflective characteristics are retained.

In the instant invention, in contrast, thicker SiO₂ coatings are utilized to increase the overall coupling between the infrared radiation and the vibrational motions of the atoms within the infrared active material. The thickness of the vibrational infrared active material included in the instant barrier material extends to on the order of the penetration depth of thermal infrared radiation in the barrier material. As used herein, penetration depth of infrared radiation refers to the distance within the infrared active material required for the intensity of infrared radiation to diminish to 1/e (36.8%) of its incident value. In one embodiment, the vibrational infrared active material has an average thickness of greater than 0.5 μm and preferably a thickness of between 0.5 μm and 25 μm. In another embodiment, the vibrational infrared active material has a thickness of greater than 2 μm and preferably a thickness of between 2 μm and 20 μm. In yet another embodiment, the vibrational infrared active material has a thickness of greater than 4 μm and preferably a thickness of between 4 μm and 15 μm.

As indicated hereinabove, as the thickness of a vibrational infrared active material significantly exceeds the penetration depth of thermal infrared radiation, the contribution of the additional thickness to thermal insulative properties diminishes. In one embodiment, the thickness of the instant vibrational infrared active material is between 50% and 300% of the penetration depth of the peak intensity infrared wavelength in the material. In one embodiment, the thickness of the instant vibrational infrared active material is between 75% and 200% of the penetration depth of the peak intensity infrared wavelength in the material. In one embodiment, the thickness of the instant vibrational infrared active material is between 100% and 150% of the penetration depth of the peak intensity infrared wavelength in the material. As indicated hereinabove, the peak wavelength of thermal infrared radiation varies with temperature and is about 10 μm at room temperature. In one embodiment, the peak wavelength of thermal infrared radiation is between 8 μm and 12 μm. In another embodiment, the peak wavelength of thermal infrared radiation is between 9 μm and 11 μm. In other embodiments, the thickness of the instant vibrational infrared active material is as indicated above and the thermal reflection efficiency factor at the prevailing temperature is at least 5%, more preferably at least 10%, and most preferably at least 15%.

The foregoing ranges insure adequate absorption and reflectivity of thermal infrared radiation by the vibrational infrared active material to provide effective thermal insulative properties in greenhouse applications, while avoiding the costs and time associated with excess thickness of the vibrational infrared active material. In the indicated thickness ranges, the instant vibrational infrared active materials exhibit little or no anti-reflective capability in the visible (400 nm-750 nm) portion of the spectrum.

In another embodiment, the infrared active material is a non-porous material. The presence of pores alters the refractive index of the infrared active material and control of the volume fraction of pores permits control over the refractive index of the infrared active material. The volume fraction of pores may also be referred herein as the “void fraction”. If the pore volume is occupied by a material that has a lower refractive index than the surrounding portions of the infrared active material, the refractive index of the infrared active material is decreased. Similarly, if the pore volume is filled or occupied by a higher index material, the refractive index of the infrared active material is increased. The infrared active material may have the same or different refractive index as the support layer of the instant barrier material. If the void fraction is too high, however, the beneficial infrared coupling effect associated with the instant infrared active material may be compromised and it is preferable to limit the void fraction as a result. In one embodiment, the infrared active material includes a void fraction between 0.25% and 10%. In another embodiment, the infrared active material includes a void fraction between 2% and 8%. In a further embodiment, the infrared active material includes a void fraction between 4% and 6%.

In other embodiments, two or more vibrational infrared active materials may be included in the instant thermal barrier material. Vibrational infrared active materials having different compositions generally include different bonds that absorb and reflect different frequencies of infrared radiation. By combining multiple vibrational infrared active materials, greater coverage of the thermal infrared spectrum can be achieved. FIG. 2, for example, illustrates that SiO₂ provides good coverage of the infrared spectrum over selected bands, but little or no coverage of the infrared spectrum over a significant range of wavelengths. The absorption of SiO₂, for example, between about 14 μm and 18 μm is poor. Consequently, since the thermal infrared emission spectrum is a broad continuous band of wavelengths, an improved thermal barrier material can be achieved by combining SiO₂ with a material that absorbs well between 14 μm and 18 μm. In one embodiment, SiO₂ and Si₃N₄ are combined to form an infrared active material. In another embodiment, SiO₂ and TiO₂ are combined to form an infrared active material. Other materials that may be combined with SiO₂ to provide broader coverage of the infrared spectrum include SiC, GeO₂, ZnO, ZnS, Al₂O₃, and KBr.

In another embodiment, the infrared active material couples to incident infrared radiation through free carrier (electron or hole) absorption. Free carriers are mobile charge carriers contained within an infrared active material. In this embodiment, free carrier absorption by metals or transparent conductive oxides imparts strong infrared absorption or reflection characteristics to the instant barrier material. Transparent conductive oxides consist of a metal oxide and a dopant. The metal oxide itself is normally insulating and poorly conducting. Incorporation of a dopant, however, imparts conductivity by introducing free electrical charge carriers. The charge carriers, in turn, are capable of absorbing electromagnetic radiation. By controlling the concentration of dopants, the spectral range of free carrier absorption can be controlled. As dopant concentration increases, the high frequency limit of free carrier absorption increases and free carrier absorption extends to shorter wavelengths. Moderate doping concentrations establish free carrier absorption (and reflectance) in the thermal infrared spectral range, while largely preventing free carrier absorption (and reflectance) in the visible range. Thus, metal oxides that include moderate concentrations of dopants that provide free carriers remain transparent in the visible (and thus transmit the visible portions of incident solar radiation) while providing good thermal insulative characteristics in the infrared.

Illustrative transparent conducting oxide materials include indium tin oxide (In₂O₃:Sn) and zinc aluminum oxide (ZnO:Al). In these materials, the base oxides (In₂O₃, ZnO) are relatively non-conducting and the dopants (Sn, Al) introduce free carriers that impart conductivity. To maintain transparency in the visible while achieving good reflectance in the infrared, doping concentrations of ˜10¹⁹-10²⁰ cm⁻³ are recommended. Other dopants for In₂O₃ include Ge and Si and other dopants for ZnO include F, Si, Ga or In. Other base oxides include transition metal oxides, GeO₂ and SnO₂.

In a further embodiment, the infrared active layer of the instant composite material includes a combination of a transparent conducting oxide material with a material exhibiting strong vibrational absorption in the infrared. The transparent conducting oxide material and vibrational infrared absorbing material may be formed as consecutive multiple layers or formed as a single heterogeneous or homogeneous layer. This embodiment combines the beneficial infrared reflectance arising from free carriers with the strong infrared absorption of vibrational modes of Si—O, Si—N, Al—O, Al—N, Zn—O, Zn—S, Zn—Se, etc. bonds as described hereinabove in connection with vibrational infrared active materials. In one embodiment, a transparent conductive oxide (e.g. ZnO doped with Al or Ga or In₂O₃ doped with Sn, Ge or Si) may be combined with SiO₂.

A combination of a transparent conducting oxide with a vibrational infrared absorbing material may facilitate adhesion of the infrared active material with a base organic or polymer layer. Organic and polymeric materials are generally comprised of relatively non-polar covalent bonds. Transparent conducting oxide materials, in contrast, are generally comprised of relatively polar or ionic oxides. As a result, it may be difficult to achieve good adhesion at the interface between a base organic or polymer material and a transparent conducting oxide. Materials, like SiO₂, that strongly absorb in the infrared vibrational range are generally more covalent in bonding than transparent conducting oxides. The bonding within such materials often has a covalency intermediate between the predominantly ionic bonding of transparent conducting oxides and the predominantly covalent organic or polymer base material. As a result, it is expected that inclusion of a material like SiO₂ in the infrared active material will promote adhesion of the infrared active material with a base organic or polymer material.

In other embodiments of the instant invention, good reflectance in the infrared is achieved through free carrier absorption of a metal. It is well known that metals have high reflectivity in the infrared, but use of metals as the infrared active material in a greenhouse barrier material is complicated by the need for the barrier to also transmit the visible portions of the solar spectrum. Because of their high free carrier concentration, metals strongly absorb visible radiation have higher reflectance and do not transmit it. To achieve good reflectance in the infrared and adequate transmission of visible light, it is necessary to control the number of free carriers. As the free carrier concentration increases, infrared reflectance increases, but visible transmission decreases. If the free carrier concentration is too low, visible transmittance is good, but infrared reflection is poor. Accordingly, it is necessary to carefully control the free carrier concentration to achieve an operable thermal barrier. In one embodiment, the free carrier concentration is between 10¹⁷ cm⁻³ and 10²² cm⁻³. In another embodiment, the free carrier concentration is between 10¹⁸ cm⁻³ and 10²¹ cm⁻³. In a further embodiment, the free carrier concentration is between 10¹⁹ cm⁻³ and 10²⁰ cm⁻³.

The instant inventor has identified two solutions to the problem of retaining high reflectivity of a metal in the thermal infrared range, while achieving adequate transmission of incident visible radiation. First, if the thickness of a metal coating placed on an organic or polymer substrate is sufficiently small (e.g. Angstrom or nanometer scale), visible light will pass through a metal. In order for this solution to be effective, the thickness generally needs to be less than the penetration depth of visible light in the metal. Preferably, the thickness is significantly less than this penetration depth. In one embodiment, the thickness of an infrared active material comprising a metal is less than 30 nm.

Second, the metal can be distributed as a non-contiguous layer on an organic or polymer base layer. Discrete, spatially separated metal regions continue to provide reflectivity of thermal infrared radiation while leaving windows or uncovered regions for transmission of visible radiation. In addition, the free carrier concentration of discrete metallic regions can be varied by controlling the dimensions of the metallic regions. As the dimensions of the metallic regions decrease from bulk dimensions and enter the nanoscale regime, the free carrier concentration generally decreases. In one embodiment, the instant metallic regions have a lateral dimension of less than 10 nm. In another embodiment, the instant metallic regions have a lateral dimension of less than 5 nm. In a further embodiment, the instant metallic regions have a lateral dimension of less than 2 nm.

The discrete metal regions may be randomly dispersed on the surface of the base layer or arranged in a pattern, or even dispersed throughout its volume. To improve visible transmission, the discrete regions may further be formed with a thickness below the penetration depth of visible light. In this embodiment, a fraction of visible light intensity will pass through the discrete metal regions. In a further embodiment, the physical dimensions of the discrete metal regions are less than the wavelength of the incident visible light. As the dimensions of the discrete metal regions become small relative to the wavelength of incident visible light, the optical constants perceived by the incident light reflect an average of the environment sampled by the light on the wavelength scale. The net result is a diminution of the visible reflective characteristics of the discrete metal regions.

The discrete metal regions may be deposited directly on the organic or polymer base layer or may be incorporated in a matrix. The matrix may serve as a protective layer to prevent oxidation of the discrete metal regions and may also itself contribute to an improvement in thermal insulative characteristics of the barrier material. In one embodiment, the matrix is a vibrational infrared active material as described hereinabove. In another embodiment, the matrix is a transparent conductive oxide material as described hereinabove.

In one embodiment, the discrete metal regions are comprised of Al. Al is a particularly convenient metal to include in the instant thermal barrier material because of its tendency to segregate into nanoscale islands, instead of monolayers, during deposition and growth. In one embodiment, the infrared active material includes a matrix of SiO₂ with nanoscale regions of Al formed therein. In another embodiment, the infrared active material includes nanoscale regions of Al sandwiched between two layers of SiO₂.

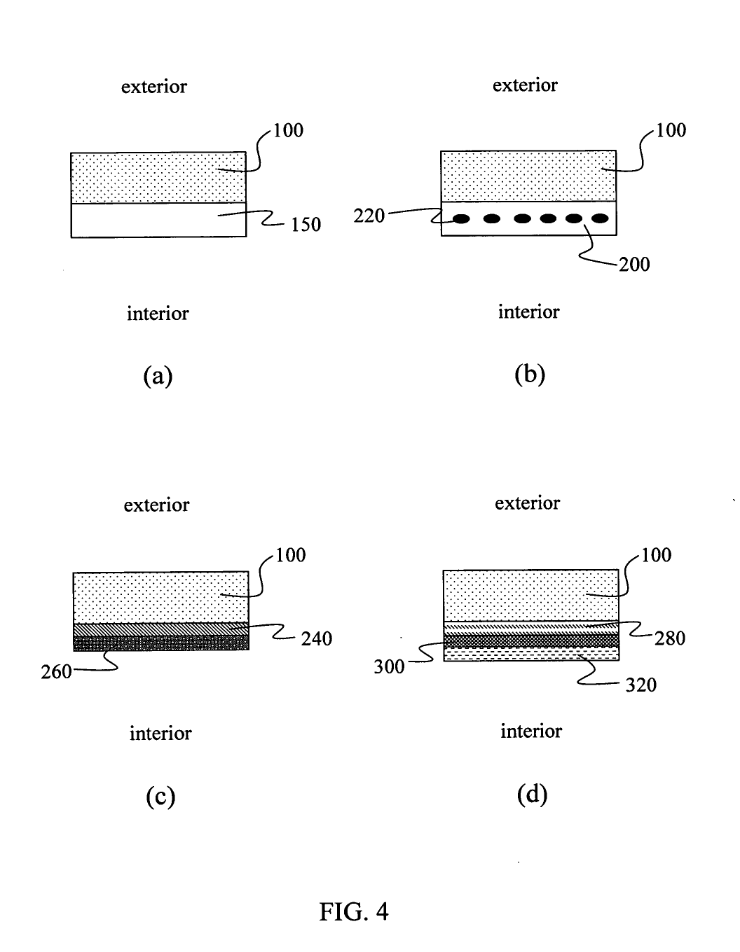

A schematic depiction of illustrative embodiments of thermal barriers in accordance with the instant invention is presented in FIG. 4. FIG. 4(a) shows a thermal barrier that includes a supporting organic or polymer layer 100 and infrared active layer 150. The barrier defines a boundary that distinguishes an interior portion from an exterior portion. In a greenhouse application, for example, the interior portion corresponds to the space where crops are grown and the exterior portion corresponds to the surrounding ambient. Infrared active layer 150 is positioned on the interior portion of support layer 100 and provides thermal insulative benefits as described hereinabove. Infrared active layer 150 may be a homogeneous layer or a heterogeneous layer that includes a blend or physical mixture of two or more components. As indicated hereinabove, combinations of multiple infrared active materials may provide enhanced reflectivity of thermal infrared radiation by providing broader coverage of the thermal infrared spectral region. FIG. 4(b) shows a barrier that includes support layer 100 and a composite infrared active material that includes matrix 200 and discrete metal regions 220, where matrix 200 and discrete metal regions 220 are as described hereinabove. Discrete metal regions 220 may be formed as a separate layer on or between one or more surrounding layers or may be incorporated through physical mixing with the matrix material 200. FIG. 4(c) shows a barrier that includes support layer 100 and a composite infrared active material that includes multiple layers. Layers 240 and 260 may mix or match two different infrared active materials; an infrared active material and a transparent conductive oxide material; two different transparent conductive oxide materials; an infrared active material and a composite material including a matrix and discrete metal regions; two different composite materials, each of which includes a matrix and discrete metal regions; a transparent conductive oxide material and a composite material that includes a matrix and discrete metal regions; etc. FIG. 4d shows a barrier that includes support layer 100 and a three-layer infrared active material that includes metal layer 300 sandwiched between adjacent layers 280 and 320, where layers 280 and 320 may be infrared active materials, transparent conductive oxide materials, composite materials including a matrix and metal islands, or a combination thereof. But more than 3 layers are also included.

In further embodiments, the instant barrier materials may also include an antireflective coating deposited on the exterior side of support layer 100 shown in FIGS. 4(a)-4(d). The antireflective coating is intended to facilitate the transmission of the visible part of the solar (or other) spectrum through support layer 100 by reducing visible light reflection at the exterior surface of support layer 100. In the absence of an antireflective coating, the high refractive index of most plastics and organic materials leads to significant reflection losses in the visible (and near-infrared) portion of the spectrum. In the case of PET, for example, reflection losses of over 6% are expected. By coating the exterior side of PET with SiO₂ at a thickness within the antireflective range, the reflection losses can be reduced to 1.5%.

In further embodiments, an infrared active material (of any of the varieties described hereinabove, alone or in combination) may be formed on both the interior side and exterior side of support layer 100. Inclusion of an infrared active material on the exterior side acts to reduce the emissivity of the support layer. As the support layer is exposed to incident thermal infrared radiation from objects within the interior of barrier material, it may absorb a fraction of the radiation and may thereby become heated. As the support layer heats, it emits its own thermal infrared radiation. This radiation is in effect a conversion of infrared radiation from interior objects to infrared radiation of the barrier material and represents a potential source of lost infrared radiation that decreases the efficiency of the thermal barrier. To ameliorate the effect of heating of the support layer, an infrared active material may be placed on the exterior side of the support layer to reflect thermal infrared radiation emitted by the support layer and prevent its escape to the surroundings. This low-e layer does not actually reflect the IR light. But it does interfere with the natural ability of a material to emit energy at the surface.

The infrared active materials of the instant invention can be prepared by various methods. The methods permit formation of the infrared active materials described hereinabove on a natural or synthetic organic or polymer support layer. The support layer may be a sheet, a single fiber, cloth, clothing, fabric, wallpaper, etc. The infrared active material (including vibrational infrared active materials, transparent conductive oxides, nanoscale metals, and metal islands) may be formed by various deposition techniques such as chemical vapor deposition, plasma enhanced chemical vapor deposition, physical vapor deposition, sputtering, reactive sputtering, evaporation, solution phase spray-on deposition (e.g. sol-gel methods or precipitation), photochemical or photo-assisted methods, and electrochemical methods (e.g. electroplating). Physical dimensions of the nano-scale and metal islands may be naturally formed, or controlled purposely by lithography and the like.

### Example 1

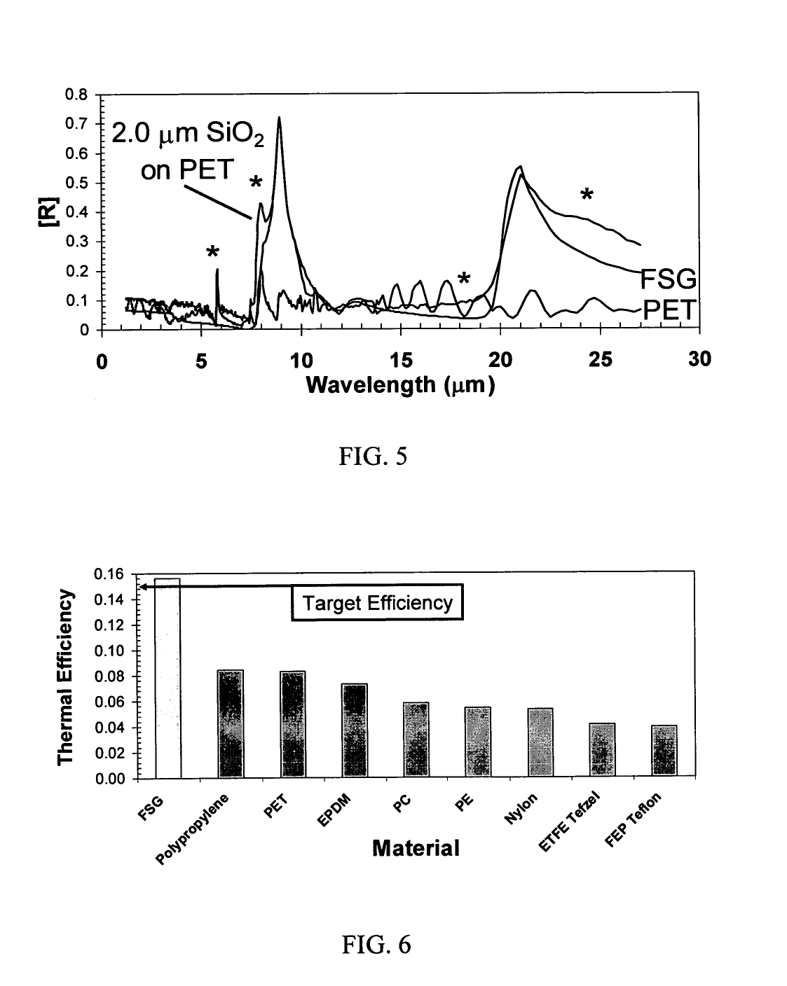

In this example, the properties of a thermal barrier according to the instant invention are described. FIG. 5 compares the reflectance spectra of a 5 mil thick sample of PET (Mylar, trace labeled “PET”), a 5 mil thick sample of SiO₂ (fused silica glass, trace labeled “FSG”) and a thermal energy barrier that includes a 2 μm thick layer of SiO₂ as infrared active layer on a 5 mil thick PET support layer (trace labeled “2.0 μm on SiO₂ on PET”). The traces shown for PET and FSG are reproduced from FIG. 3. The trace shown for the thermal energy barrier indicates that the instant barrier material provides infrared reflection characteristics that are superior to those of SiO₂ alone. First, it is noteworthy that a 2 μm thick layer of SiO₂ is thick enough to incorporate the infrared reflection characteristics of the 5 mil thick SiO₂ sample. This confirms that the surface region of SiO₂ (or other vibrational infrared active materials) is primarily responsible for the thermal insulative benefits. Second, due to synergistic interactions between overlapping bands of PET and SiO₂ in the infrared, the composite barrier material in fact provides greater reflectivity in the infrared than free-standing SiO₂. The asterisks shown in FIG. 5 denote portions of the infrared spectrum where the composite SiO₂—PET barrier material provides superior infrared reflectivity than fused silica glass alone.

The reflectance spectrum shown in FIG. 5 can be used to compute the thermal reflection efficiency of the barrier material, PET, and fused silica glass. The thermal reflection efficiency ∈ₜₕₑᵣₘₐₗ can be defined as the ratio of the actual reflected power to the ideal blackbody radiation power over a given spectral range and can be computed as follows:

$${ɛ}_{thermal} ≡ \frac{{p}_{reflected}}{{p}_{incident}} = \frac{{\int }_{min}^{max} G ( λ , T ) R ( λ ) d λ}{{\int }_{min}^{max} G ( λ , T ) d λ}$$

$$G ( λ , T ) = \frac{2 π {hc}^{2}}{{λ}^{5}} \times \frac{1}{{e}^{hc / λ {K}_{B} T} - 1}$$

where P_{reflected} is the reflected power, P_{incident} is the blackbody power incident on the boundary material from the interior, G(λ,T) is blackbody emission profile, λ is wavelength, T is absolute temperature, R(λ) is the reflectance spectrum, and the integration occurs between a minimum and maximum wavelength within a spectral range of interest. In principle, the integration should extend from 0 to ∞ to account for all radiation. In practice, however, spectral reflectance data is limited experimentally by instrumentation. Accordingly, for the purposes of this example, thermal efficiencies are computed at room temperature (T=293 K) for wavelengths extending from 1.25 μm to 27 μm.

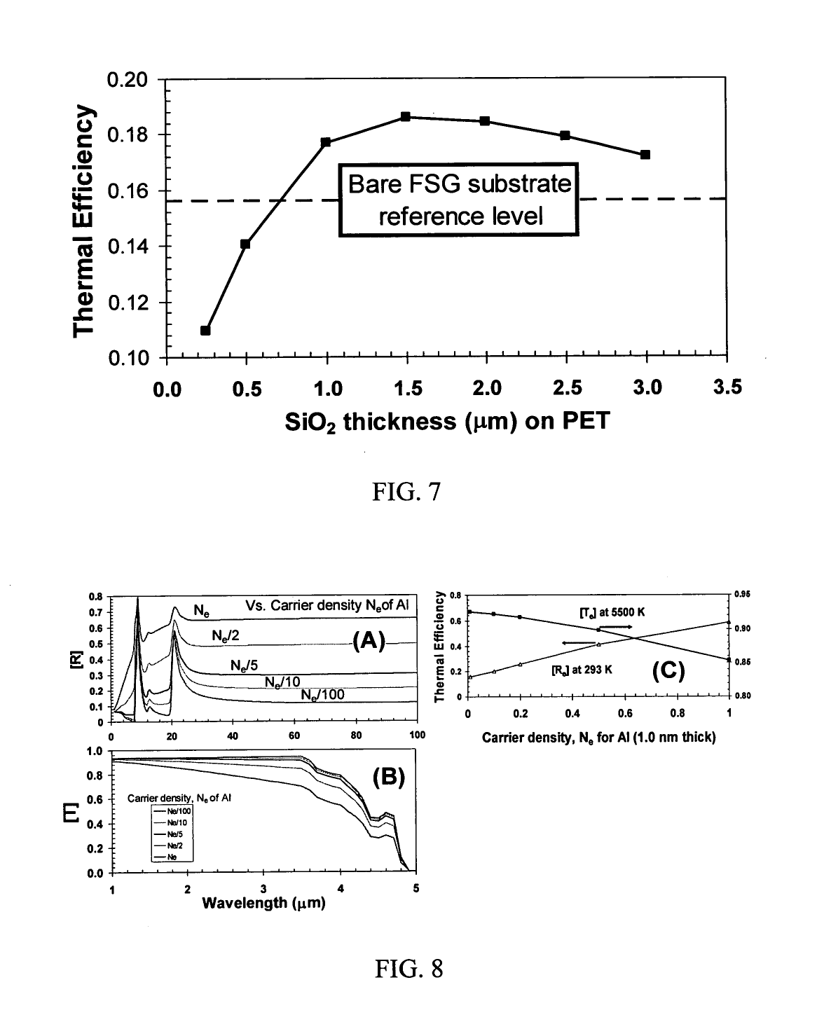

The results of thermal reflection efficiency calculations are shown in FIGS. 6 and 7. FIG. 6 shows the results for fused silica glass, PET, and several other polymer materials. The thickness of fused silica glass was 125 mil and the thickness for PET and the other polymer materials was 5 mil. The results show that the thermal efficiencies for fused silica glass and PET are about 15.6% and 8%, respectively. FIG. 7 shows the thermal efficiency of SiO₂-coated PET as a function of the thickness of SiO₂. At the 2 μm thickness of the sample shown in FIG. 5, the thermal efficiency of the SiO₂-coated PET is about 18.6%. FIG. 7 also includes a reference line corresponding to the 15.6% thermal efficiency of free standing fused silica glass. The results indicate that SiO₂-coated PET provides a higher thermal efficiency than free-standing fused silica glass over a wide range of thicknesses.

### Example 2

In this example, the beneficial effect of nanoscale regions of Al is demonstrated through simulation. The free carrier absorption characteristics of Al vary with the particle size of Al. Maximum free carrier absorption occurs for bulk Al and the free carrier absorption decreases as the particle size decreases due to a decrease in the concentration of free carriers as the dimensions of Al particles decrease. In this example, the free carrier concentration Nₑ and optical constants of bulk Al were determined through a Drude-Lorentz analysis of optical data in the visible to near-infrared spectral range and the results were applied to compute the reflectance and transmission spectra of Al films having a thickness of 1.0 nm over a range of Al particle sizes.

FIG. 8 summarizes the results of the spectral response and thermal efficiency of Al as a function of particle size, where free carrier concentration Nₑ was utilized as a proxy for particle size. The results were simulated over a range of free carrier concentrations ranging from the bulk value Nₑ to a value of 1% of Nₑ. Decreasing free carrier concentration correlates with smaller particle size and an evolution of Al from a bulk, continuous layer to discrete, separated, island-like domains. The results were determined for Al supported on a SiO₂ glass substrate, where the structure is surrounded by air. The structure corresponds to a thermal barrier material in which the SiO₂ side is exposed to the exterior (e.g. sun) and the Al layer is exposed to the interior of the boundary defined by the barrier material.

FIG. 8A shows the reflectance spectrum of Al as a function of wavelength (in units of μm) for several particle sizes. The trace labeled Nₑ corresponds to bulk Al. Bulk Al exhibits the greatest reflectance over the range of wavelengths. The reflectance spectrum includes two principle peaks (˜9 μm and ˜21 μm) due to Si—O vibrations of the glass superimposed on a broad background reflectance band that levels off above 60% at longer wavelengths. As the free carrier concentration and Al particle size are reduced, the two principle peaks remain while the broad background reflectance decreases appreciably. The results indicate that the reflectivity of Al decreases as the particle size decreases and are consistent with the expected trend as Al evolves from a continuous layer to a non-contiguous layer with increasingly smaller Al features.

FIG. 8B shows the transmittance spectrum in the near-infrared region of Al as a function of particle size. The transmittance spectrum is a measure of the fraction of incident light that passes through the Al layer as a function of wavelength. The results indicate that bulk Al (trace Nₑ) has the lowest transmittance over the range of wavelengths and that transmittance increases as the particle size of Al decreases. The results are consistent with expectations because bulk Al corresponds to a continuous layer, while discrete Al regions correspond to a non-contiguous layer whose effective carrier density (Nₑ) is controlled by the particle size.

FIG. 8C shows the thermal reflection efficiency of reflectance and transmission of Al as a function of particle size. The reflection efficiency was determined for a temperature of 293 K as indicated hereinabove based on the ratio of the reflected power to the incident power using the reflectance spectra shown in FIG. 8A. The transmission efficiency was similarly calculated using the transmission spectra shown in FIG. 8B and a temperature of 5500 K. The temperature used for transmission efficiency corresponds to the blackbody temperature of the sun so that the transmission efficiency represents the efficiency of solar transmission through the Al layers from the exterior side of the barrier material. The reflection efficiency, in contrast, represents the efficiency of thermal infrared reflectivity based on thermal infrared emission from objects on the interior side of the barrier material. FIG. 8C generally shows that the transmission efficiency increases and the reflectance efficiency decreases as the particle size of Al decreases. A trade-off between transmission efficiency (of incident solar radiation from the exterior through the barrier to the interior) and reflectance efficiency (of thermal infrared radiation emanating from objects in the interior) is observed. A higher solar transmission occurs at the expense of retaining thermal infrared radiation. The results indicate, however, that nanoscale Al provides both high visible transmittance and high infrared reflectance relative to free-standing SiO₂ glass. At an Al size having a free carrier concentration of 50% of Nₑ, for example, the solar transmission efficiency is 90% and the thermal reflection efficiency is 40% (which is more than twice the thermal reflection efficiency of free-standing fused silica glass).

### Example 3

In this example, the instant infrared active materials are applied to clothing. In clothing applications, it is desirable to achieve retention of body heat in cold climates. The body is an approximately fixed temperature thermal source that emits infrared radiation. Retention of infrared radiation emitted from the body keeps the body warm and prevents heat loss to the surroundings. The enhanced thermal insulative effects described hereinabove extend to the fabrics, cloth, fibers, and threads used to make clothing.

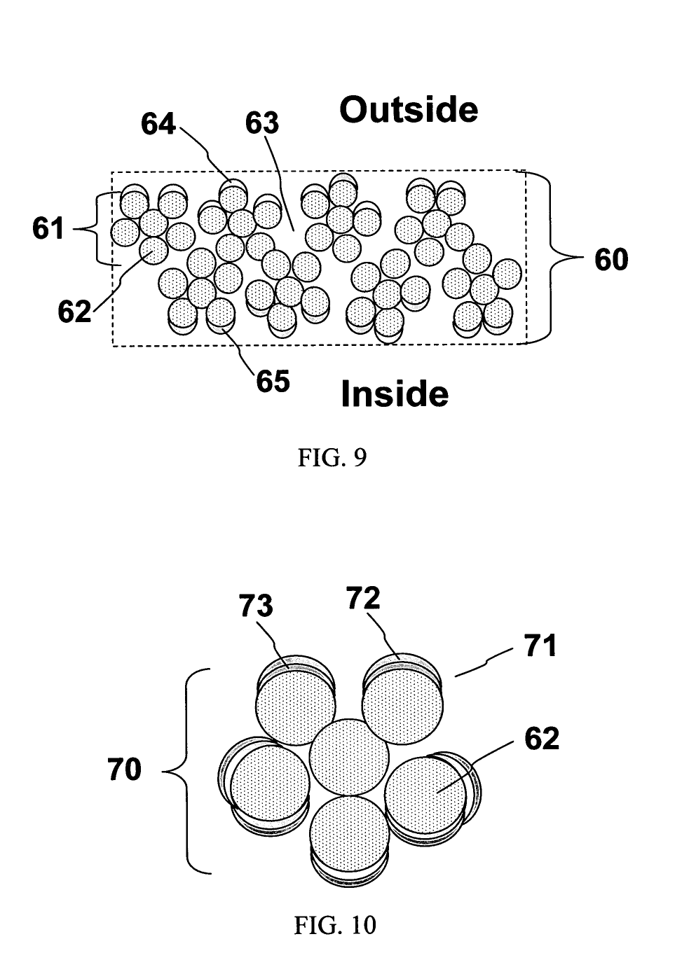

FIG. 9 depicts an embodiment in which an infrared active material is formed on the exterior surface of textile. Textile 60 is a natural or synthetic material formed from threads 61 that include fibers 62. After manufacture, the interior and exterior surfaces of the textile may be treated with an infrared active material according to the instant invention. The interior surface of the textile is the side in contact with the body and the exterior surface is the side exposed to the external surroundings. Infrared active material 64 is formed on the exterior side of textile 60 and infrared active material 65 is formed on the interior side of textile 60. Infrared active materials 64 and 65 may be the same or different material and each may be a single layer or multilayer material that includes one or more of a vibrational infrared active material, transparent conductive oxide, or nanoscale metal material as described hereinabove.

The micron-scale thickness of the instant infrared active material provides an advantage over conventional silicone treatments of textiles known in the art. Silicones are silicon-oxygen polymers that are sprayed over a fabric to provide a protective layer that imparts water resistance. Silicones, however, suffer from two drawbacks. First, silicones are poor reflectors of thermal infrared radiation. Even though silicones contain infrared active Si—O bonds, the concentration of such bonds relative to SiO₂ is low and the infrared thermal reflectivity is accordingly reduced. Second, silicones provide a thick coating that blocks the spaces 63 between fibers, thus impairing breathability and comfort. Prior art fabrics coated with Al paint provide greater infrared reflectivity, but still suffer from poor breathability and alter the coloration or appearance of the garment as well. With the instant infrared active material, spaces 63 are not filled and the textile remains permeable to oxygen and moisture to provide the user with added comfort without compromising appearance or style.

The instant infrared active material may be applied to the interior and exterior surfaces of all layers of a multilayer textile product. A jacket, for example, normally includes an interior liner and an exterior shell with an intervening layer of insulation. The shell, liner and insulation may be separately coated with an infrared active material according to the instant invention to provide added thermal insulative capability and superior performance over conventional fabrics.

FIG. 10 illustrates an alternative embodiment in which the individual fibers of the threads used to make textiles are coated with an infrared active material according to the instant invention. Thread 70 includes natural or synthetic fibers 62 which include multi-layer infrared active coatings 71. Infrared active coatings 71 include first layer 72 and second layer 73. Once coated, the threads can be combined and sewn or stitched to form a textile. In this embodiment, the infrared active material is present within the interior of the textile and not simply at the surface thereof.

The principles described in this example apply to all manner of textile, whether wearable (e.g. garments, clothing) or not (e.g. tents, blankets, sheets, pillows, upholstery, curtains). The principles also extend to common insulation materials (e.g. fiber glass, foam) and such materials may be coated with the instant infrared active materials to achieve improved thermal retention characteristics. Additionally, the instant invention extends to rugs, carpeting, wallpaper, drapes, shingles, and other materials placed on walls, floors, ceilings, roofs, or windows. Incorporation of the instant infrared active materials on such materials increases heat retention through enhanced reflectance and reduced losses of thermal infrared radiation to the exterior of a dwelling.

Those skilled in the art will appreciate that the methods and designs described above have additional applications and that the relevant applications are not limited to those specifically recited above. Also, the present invention may be embodied in other specific forms without departing from the essential characteristics as described herein. The embodiments described above are to be considered in all respects as illustrative only and not restrictive in any manner.

We claim:

1. A thermal energy barrier comprising:
a support layer, said support layer including an organic material and having a first side and a second side;
a first infrared active layer formed on said first side of said support layer, said first infrared active material including free charge carriers, said free charge carriers absorbing a first wavelength of infrared radiation,
wherein the concentration of said free charge carriers is between 10¹⁷ cm⁻³ and 10²² cm⁻³.

2. The thermal energy barrier of claim 1, wherein said concentration of free charge carriers is between 10¹⁸ cm⁻³ and 10²¹ cm⁻³.

3. The thermal energy barrier of claim 1, wherein said concentration of free charge carriers is between 10¹⁹ cm⁻³ and 10²⁰ cm⁻³.

4. The thermal energy barrier of claim 1, wherein said support layer is a polymer.

5. The thermal energy barrier of claim 1, wherein said support layer is a fabric.

6. The thermal energy barrier of claim 1, wherein said support layer is wallpaper or carpet.

7. The thermal energy barrier of claim 1, wherein said first infrared active material is a transparent conductive oxide.

8. The thermal energy barrier of claim 7, wherein said transparent conductive oxide comprises Sn or Zn.

9. The thermal energy barrier of claim 7, wherein said first infrared active material further comprises discrete metal regions distributed within said transparent conductive oxide.

10. The thermal energy barrier of claim 1, wherein said first infrared active material comprises metallic regions.

11. The thermal energy barrier of claim 10, wherein said metallic regions are discrete.

12. The thermal energy barrier of claim 11, wherein said discrete metallic regions have a lateral dimension of less than 10 nm.

13. The thermal energy barrier of claim 12, wherein said discrete metallic regions have a lateral dimension of less than 5 nm.

14. The thermal energy barrier of claim 13, wherein said discrete metallic regions have a lateral dimension of less than 2 nm.

15. The thermal energy barrier of claim 11, wherein said discrete metallic regions are embedded in a non-metallic matrix.

16. The thermal energy barrier of claim 15, wherein said non-metallic matrix is an oxide or nitride.

17. The thermal energy barrier of claim 10, wherein said metallic regions comprise Al.

18. The thermal energy barrier of claim 1, wherein said barrier material is in an external ambient having a first temperature and said first wavelength of infrared radiation is the peak wavelength of blackbody emission at said first temperature.

19. The thermal energy barrier of claim 18, wherein said peak wavelength of blackbody emission is between 8 μm and 12 μm.

20. The thermal energy barrier of claim 1, wherein the thermal reflection efficiency infrared radiation from said barrier is at least 10%.

21. The thermal energy barrier of claim 20, wherein the average transmittance of light having wavelengths between 400 nm and 750 nm through said barrier is at least 50%.

22. The thermal energy barrier of claim 1, wherein said barrier further comprises a second infrared active material formed on said first infrared active material, said second infrared active material including an inorganic material.

23. The thermal energy barrier of claim 22, wherein said first infrared active material comprises Al and said second infrared active material comprises an oxide or nitride.

24. The thermal energy barrier of claim 1, wherein said barrier further comprises a second infrared active material formed on said second side of said support layer, said second infrared active material including an inorganic material.

25. The thermal energy barrier of claim 24, wherein said second infrared active material includes an oxide or nitride.

26. The thermal energy barrier of claim 25, wherein said second infrared active material further includes discrete metal regions.

27. The thermal energy barrier of claim 1, wherein said barrier further comprises an anti-reflective coating formed on said second side of said support layer.
